(19) United States
(12) Patent Application Publication
(10) Pub. No.: US 2024/0032022 A1
(43) Pub. Date: Jan. 25, 2024

(54) PRIORITIZING TRANSMISSIONS BY USER EQUIPMENT

(71) Applicant: APPLE INC., CUPERTINO, CA (US)

(72) Inventors: Huaning NIU, San Jose, CA (US); Dawei ZHANG, Saratoga, CA (US); Jie CUI, San Jose, CA (US); Laxminarayana PILLUTLA, Cupertino, CA (US); Manasa RAGHAVAN, Sunnyvale, CA (US); Qiming LI, Beijing (CN); Sharad SAMBHWANI, San Diego, CA (US); Xiang CHEN, Campbell, CA (US); Yang TANG, San Jose, CA (US)

(21) Appl. No.: 17/441,969

(22) PCT Filed: Aug. 5, 2021
(86) PCT No.: PCT/CN2021/110830

§ 371 Date: Sep. 22, 2021

(51) Int. Cl. H04W 72/1268; H04W 72/566; H04L 1/1829

(52) U.S. Cl. CPC H04W 72/1268; H04W 72/569; H04L 1/1854

(57) ABSTRACT

The present application relates to devices and components including apparatus, systems, and methods for determining priority between body proximity sensing (BPS) transmissions and other transmissions by a user equipment (UE) (e.g., in Frequency Range 2 (FR2)).

### BACKGROUND

Third Generation Partnership Project (3GPP) Fifth Generation (5G) New Radio (NR) provides for communication between user equipment (UE) and a network (e.g., a gNB or other base station). Such communication may occupy frequency bands in Frequency Range 1 (FR1) (e.g., below 7.225 GHz), Frequency Range 2 (FR2) (e.g., 24.250 GHz and above, also called mmWave), higher frequency ranges (e.g., between 52.6 GHz and 71 GHz or 114.25 GHz), and/or other frequency ranges.

### BRIEF DESCRIPTION OF THE DRAWINGS

FIG. 1 shows a network environment in accordance with some embodiments.

FIG. 2 shows an example of a network-configured uplink (UL) gap configuration that may be provided by a gNodeB to a UE in accordance with some embodiments.

FIG. 3A illustrates an example of prioritizing transmission of a scheduled UL signal by puncturing a UL gap configuration in accordance with some embodiments.

FIG. 3B illustrates an example of prioritizing transmission of scheduled UL signal by deferring a UL gap slot in accordance with some embodiments.

FIG. 3C illustrates prioritizing body proximity sensing (BPS) transmissions by dropping UL transmissions of signals that are scheduled for slots in the UL gap configuration in accordance with some embodiments.

FIG. 4 illustrates an operational flow/algorithmic structure in accordance with some embodiments.

FIG. 5 illustrates an operational flow/algorithmic structure in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates a user equipment in accordance with some embodiments.

FIG. 9 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). For the purposes of the present document, the phrase “A is based on B” means “A is based on at least B”.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements. The term “obtaining” is used to indicate any of its ordinary meanings, such as calculating, deriving, receiving (e.g., from another element or device), and/or retrieving (e.g., from an array of storage elements).

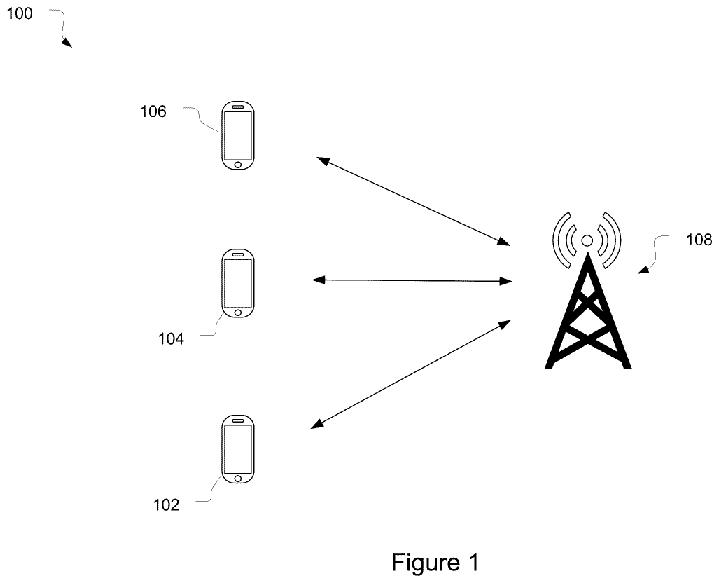

Techniques for determining priority between body proximity sensing transmissions and other transmissions by a UE (e.g., in FR2) are described. FIG. 1 illustrates a network environment 100 in accordance with some embodiments. The network environment 100 may include UEs 102, 104, and 106, and an access node (or “base station”) 108. The access node 108 may provide one or more wireless access cells, for example, 3GPP New Radio (NR) cells, through which one or more of the UEs 102/104/106 may communicate with the access node 108. In some aspects, the access node 108 is a Next Generation NodeB (gNB) that provides one or more 3GPP New Radio (NR) cells. The air interfaces over which the UEs 102/104/106 and access node 108 communicate may be compatible with 3GPP technical specifications (TSs) such as those that define Fifth Generation (5G) NR system standards and may occupy frequency bands in Frequency Range 1 (FR1) (e.g., below 7.225 GHz), FR2 (e.g., 24.250 GHz and above, also called mmWave), or higher frequency bands (e.g., between 52.6 GHz and 71 GHz or 114.25 GHz).

The access node (or “base station”) 108, which may be a gNB, may transmit information (for example, data and control signaling) in the downlink direction by mapping logical channels on the transport channels, and transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink shared channel (PDSCH); and a physical downlink control channel (PDCCH).

The PBCH may be used to broadcast system information that the UEs 102/104/106 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by a UE 102/104/106 during a cell search procedure and for beam selection.

The PDSCH may be used to transfer end-user application data, signaling radio bearer (SRB) messages, system information messages (other than, for example, a Master Information Block (MIB)), and paging messages.

The access node 108 (e.g., base station or gNB) may use a PDCCH to transmit downlink control information (DCI) to the UEs 102/104/106. The DCI may provide uplink resource allocations on a physical uplink shared channel (PUSCH), downlink resource allocations on a PDSCH, and various other control information. The DCI may also be used to provide uplink power control commands, configure a slot format, or indicate that preemption has occurred.

A UE 102/104/106 may use a Physical Uplink Control Channel (PUCCH) to transmit uplink control information (UCI) to the access node 108, which may include, for example, hybrid-automatic repeat request (HARQ) acknowledgements, scheduling requests, or periodic and semi-persistent channel state information (CSI) reports.

It may be desired to extend 5G NR to frequency bands other than those currently used. For example, NR beyond 52.6 GHz up to 114.25 GHz may be considered. Frequencies between 52.6 GHz and 71 GHz are especially interesting in the short term, because of their proximity to sub-52.6 GHz (current NR system) and imminent commercial opportunities for high data rate communications, e.g., (un)licensed spectrum between 57 GHz and 71 GHz. 5G NR in unlicensed spectrum (NR-U) provides for both license-assisted and standalone use of unlicensed spectrum.

For implementing such extension, it may be desirable to leverage Frequency Range 2 (FR2) design to the extent possible. FR2, as used herein, may indicate a frequency range of 24.25 GHz to 52.6 GHz. For example, it may be beneficial to use aspects of existing waveforms (e.g., existing downlink (DL)/uplink (UL) NR waveform) to support operation at frequencies between 52.6 GHz and 71 GHz and beyond if feasible, to take advantage of such opportunities by minimizing specification burden and required changes and maximizing the leverage of FR2-based implementations. Such aspects may include applicable numerology including subcarrier spacing (SCS), channel BW (including maximum), and their impact to FR2 physical layer design to support system functionality considering, for example, practical radio-frequency (RF) impairments; channel access mechanism assuming beam-based operation in order to comply with the regulatory requirements applicable to unlicensed spectrum for frequencies between 52.6 GHz and 71 GHz, etc.

It may be desired to further enhance FR2 coverage, signal quality, and/or UE performance. For example, it may be desired to improve power efficiency and/or overall system throughput. Some FR2 enhancements may involve operations that should be performed during run-time but may not be compatible with transmission and/or reception of data or control signals (e.g., calibration and/or measurement operations). Due to unavoidable hardware sharing, various identified FR2 enhancements may rely on and benefit from a periodic uplink (UL) gap, during which time the UE can perform calibration and measurement (e.g., over the air and/or through an internal loop) without interrupting UL transmission/reception (Tx/Rx). Examples of such operations may include UE transmit (Tx) power management. For example, it may be desired for a UE to adaptively and efficiently adjust its output power to maximize UL coverage and/or throughput while maintaining compliance with regulatory requirements. Transmit power management may benefit from periodic monitoring of information from the surrounding environment (e.g., body proximity sensing or BPS).

Other self-calibration and/or monitoring operations are not precluded. At least some of the aforementioned self-calibration and monitoring mechanisms may be generalized as a basic scheme in which the UE sends and receives a calibration signal, either over the air or through another internal loop between Tx and Rx hardware. Since the hardware used for UL transmission is partially shared by self-calibration and monitoring, UL transmission may be interrupted momentarily by such an operation. It may be desired to minimize such disruption by providing a UE-specific and network-configured UL gap, during which time the UE can perform operations for FR2 RF enhancement, such as calibration and/or measurement (e.g., transceiver calibration and Tx power management). The gNB does not expect to receive an UL transmission from the UE during the UL gap, and if the gNB receives a transmission from the UE during the UL gap, it may ignore it as an error.

It may be desired for a UL gap configuration, which may specify values such as gap length, gap periodicity and/or gap offset, to be UE-specific and network-configured (e.g., configured via Radio Resource Control (RRC) and/or Medium Access Control-Control Element (MAC-CE)). In one example, the gNB 108 may provide the UL gap configuration to a UE 102/104/106 in an information element (e.g., ULGapConfig), which may be carried by a RRC message (e.g., a RRC Reconfiguration message). The network may decide whether or not to provide an UL gap configuration to a UE.

A gNB 108 may provide a UL gap configuration to a UE 102/104/106 in response to an event-triggered request from the UE. Examples of such an event may include an indication that a value of a monitored parameter has exceeded a specified threshold value for the monitored parameter. One example of such an indication may be a detection by the UE that a temperature has risen above a specified threshold value (e.g., indicating that the UE needs online calibration). Another example of such an event may be a determination by the UE that body proximity sensing (BPS) is to be performed. A UE may perform BPS sensing by, for example, causing the transceiver to emit a signal (also called a “BPS transmission”) and then measuring a power of the reflected signal. BPS sensing may be used to estimate Power Management-Maximum Power Reduction (P-MPR), and a determination by the UE that BPS is to be performed may arise in a situation such as either of the following: 1) when the UE has large amount of data to transmit, and/or 2) when the UE is in a cell edge, and needs maximum transmit power for coverage. It may be possible for a gNB 108 to provide more than one UL gap configuration to a UE 102/104/106. A UE 102/104/106 may indicate its capability to perform BPS to a gNB 108 (e.g., via capability signaling).

Once a UL gap configuration is provided to the UE, it can be additionally activated or deactivated. For example, it may be desired for the gNB to activate and/or deactivate an UL gap configuration via MAC CE and/or DCI signaling. A UE may request activation of a UL gap configuration in response to a trigger event as described above (e.g., a detection by the UE that a temperature has risen above a specified threshold value, a determination by the UE that BPS is to be performed). Alternatively or additionally, a gNB may implicitly activate a UL gap configuration in response to, for example, a power headroom (PHR) report from the UE (e.g., to minimize signaling).

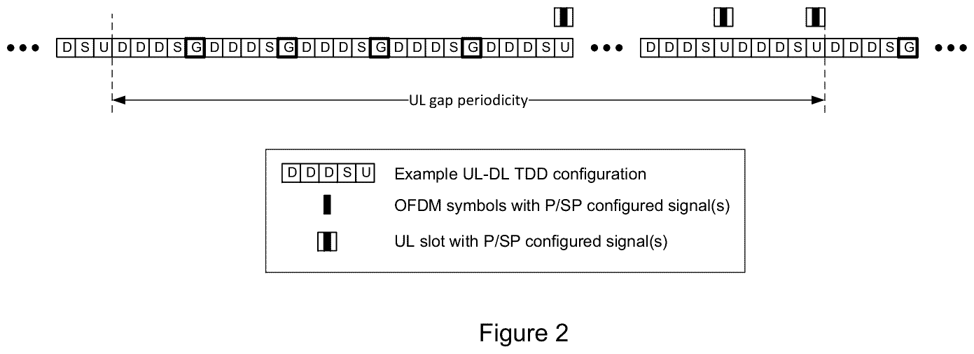

FIG. 2 shows an example of a network-configured UL gap configuration that may be provided by a gNB 108 to a UE 102/104/106 in accordance with some embodiments. In this example, the UL/DL time-division duplex (TDD) configuration is DDDSU (e.g., as may be currently used in FR2 deployments). This TDD configuration includes three DL slots (D), followed by a special slot (S), followed by an UL slot (U). A special slot includes ten symbols for DL, followed by two symbols for a gap (e.g., for receive-to-transmit RF re-tuning), followed by two symbols for UL. The UL gap periodicity (e.g., as indicated in the UL gap configuration) may have a value of, for example, 5 ms, 10 ms, 40 ms, 80 ms, 160 ms, 320 ms, or some other value. A typical UL gap periodicity (e.g., the length of one cycle of the UL gap configuration) may be, for example, 20 ms. The UL gap duration (e.g., as indicated in the UL gap configuration) may have a value of, for example, 62.5 us, 125 us, 250 us, 500 us, 1000 us, or some other value. The UL gap length (e.g., as indicated in the UL gap configuration) may have a value of, for example, one, two, four, or eight slots, or some other value. It may be desired for a UL gap configuration to include a value for UL gap duration (e.g., in units of microseconds) or a value for UL gap length (e.g., in units of slots). In this example, the gap length of the UL gap configuration is four slots, and the four U slots that are reconfigured for UL gap by the UL gap configuration are outlined and labeled G. Also indicated in FIG. 2 are UL slots in which UL transmissions of periodic or semi-persistent (P/SP) configured signals (e.g., as described below) are scheduled (e.g., on one or more OFDM symbols of the slot).

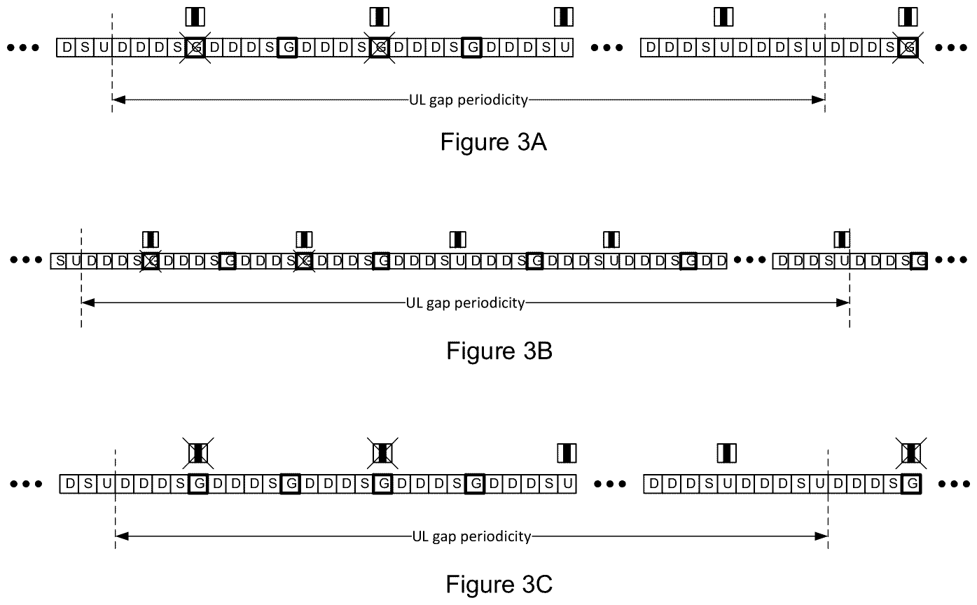

A collision may arise if a BPS transmission is scheduled to occur in the same UL slot as another transmission by the UE (e.g., an UL transmission). FIGS. 3A, 3B, and 3C show examples of such collisions for the example UL gap configuration shown in FIG. 2. Relative priorities between BPS transmissions and UL transmissions may be established (e.g., in one or more 3GPP Technical Specifications) to indicate which of the colliding transmissions should proceed and which should be dropped. Such relative priorities may be embodied, for example, in one or more priority rules.

A UE 102/104/106 may apply different relative priorities between BPS transmissions and UL transmissions in different corresponding situations. For example, the relative priority to be applied may depend on the type of signal that is to be transmitted in the conflicting UL transmission. In one example, such signals may be broadly divided into two classes: periodic or semi-persistent (P/SP) configured signals, and dynamic configured signals.

A P/SP configured signal may include UL symbols in any part of an UL slot, and a gNB 108 may provide a configuration for a P/SP configured signal by, for example, RRC messaging (e.g., in one or more information elements (IEs) within one or more RRC messages). Examples of P/SP configured signals may include a scheduling request (SR), a beam failure recovery (BFR) signal on the PUCCH (PUCCH-BFR), a P/SP configured channel status indicator (CSI) signal on the PUCCH or PUSCH, a signal transmitted on a physical random access channel (PRACH), a P/SP configured sounding reference signal (SRS), a configured grant (CG) signal on the PUSCH (CG-PUSCH), or a hybrid automatic repeat request acknowledgement (HARQ-ACK) for a downlink semi-persistent scheduled (SPS) transmission (e.g., on the PDSCH).

Several options for a priority rule between a BPS transmission and an UL transmission that is a P/SP configured signal on a static UL slot are now discussed. The term “static UL slot” indicates a slot that is configured as UL by RRC signaling and remains configured as UL until otherwise reconfigured by RRC signaling (e.g., a static UL slot is not otherwise reconfigured by DCI).

In a first option for a priority rule between a BPS transmission and an UL transmission that is a P/SP configured signal on a static UL slot, the network schedules UL transmissions of P/SP configured signals to avoid placing such transmissions in slots that are or may be configured for UL gap. Such scheduling is difficult to achieve for all the UL slots that carry P/SP configured signals, however, as the number of P/SP configured signals is usually too large to accommodate such scheduling.

A second option for a priority rule between a BPS transmission and an UL transmission that is a P/SP configured signal on a static UL slot is to prioritize transmission of the P/SP configured signal. In a first example of this option, a UE 102/104/106 may prioritize transmission of the P/SP configured signal by puncturing the UL gap configuration. FIG. 3A illustrates an example of prioritizing transmission of a P/SP configured signal by puncturing the UL gap configuration in accordance with some embodiments. In this example, the punctured UL gap slots in which a prioritized UL transmission is performed instead of the BPS transmission are indicated by being crossed out.

In a second example of the option to prioritize transmission of the P/SP configured signal, UE 102/104/106 may prioritize transmission of the P/SP configured signal by deferring the UL gap slot. In this case, it may be desired that UL slots with periodic and SP transmissions (e.g., CQI, SRS) are not counted as static UL slots. Due to the number of UL signals that may be configured in the UL channels, it is possible that at least one opportunity for transmission of a P/SP configured signal has been scheduled for every static UL slot. It may be desired to apply this second example only to selected P/SP configured signals. In such case, it may be desired to apply another relative priority to other P/SP configured signals (e.g., as described below). FIG. 3B illustrates an example of prioritizing transmission of a P/SP configured signal by deferring the UL gap slot in accordance with some embodiments. Such a rule may be implemented to allow the UE to defer a UL gap slot to a UL slot that occurs beyond the gap length of the UL gap configuration. In the example shown in FIG. 3B, prioritization of the P/SP configured signals continues beyond the UL gap configuration, and the two deferred gap slots occur two and four UL slots, respectively, after the last slot of the UL gap configuration.

A third option for a priority rule between a BPS transmission and an UL transmission that is a P/SP configured signal on a static UL slot is to prioritize the BPS transmission. A UE 102/104/106 may prioritize the BPS transmission, for example, by dropping the UL transmission of the P/SP configured signal that is scheduled for the slot in which the collision occurs. FIG. 3C illustrates prioritizing BPS transmissions by dropping UL transmissions of P/SP configured signals (indicated by being crossed out) that are scheduled for slots in the UL gap configuration in accordance with some embodiments.

It may be desired for a UE to apply more than one relative priority between BPS transmissions and UL transmissions that are P/SP configured signals. The relative priority that is to be applied to a particular collision may be based, for example, on the type of P/SP configured signal that is scheduled for transmission in the UL gap slot. In one such example, a rule to prioritize transmission of the P/SP configured signal by puncturing the UL gap configuration (e.g., as described above with reference to FIG. 3A) is applied (e.g., by a UE 102/104/106) when the P/SP configured signal is a PUCCH-BFR; a rule to prioritize transmission of the P/SP configured signal by deferring the UL gap slot (e.g., as described above with reference to FIG. 3B) is applied when the P/SP configured signal is a HARQ-ACK for DL SPS transmission; and a rule to prioritize the BPS transmission (e.g., as described above with reference to FIG. 3C) is applied for other P/SP configured signals. Other selections among the relative priorities as described above (e.g., based on the type of P/SP configured signal that is scheduled for transmission in the UL gap slot) may also be implemented.

A P configuration for a signal remains active until the signal is reconfigured (e.g., by RRC signaling). For an SP configuration of a signal, the time at which the SP configuration is applied by a UE 102/104/106 that receives the configuration may differ depending upon the manner in which the configuration is activated (also called “triggered”). A SP configuration for a signal such as a type 2 CG-PUSCH or a HARQ-ACK for SPS-PDSCH, for example, may be triggered by a DCI message. In such case, the UE may apply the SP configuration for the signal immediately after the DCI decoding is successful (e.g., typically within one slot). A SP configuration for a signal such as a SP-CSI report on the PUCCH may be triggered by a MAC CE. In such case, the UE may apply the SP configuration for the signal according to a timeline such as the following (e.g., as described in clauses 5.2.1.5.2 of 3GPP TS 38.214, “Physical layer procedures for data,” v16.5.0 (2021-04)):
“When the UE would transmit a PUCCH with HARQ-ACK information in slot n corresponding to the PDSCH carrying the activation command, the indicated semi-persistent Reporting Setting should be applied starting from the first slot that is after slot n+3N^{subframe,μ} where μ is the SCS configuration for the PUCCH.”
   For example, the UE may transmit an ACK of a PDSCH carrying the MAC CE and, after three milliseconds subsequent to transmission of a last symbol of the ACK, the UE may apply the SP configuration for the signal. For the P/SP configured signals discussed herein (e.g., a type 2 CG-PUSCH, a HARQ-ACK for SPS-PDSCH, a SP-CSI report on the PUCCH), it may be desired for the UE to prioritize transmission of the P/SP configured signal by deferring the UL gap slot as discussed above (e.g., with reference to FIG. 3B).

As discussed above with reference to FIG. 3C, it may be desired for a UE 102/104/106 to prioritize BPS transmissions over at least some types of P/SP configured signals by dropping UL transmissions of the P/SP configured signals that are scheduled for slots in the UL gap configuration. In one example, the UE 102/104/106 applies such a priority rule at the next cycle of the UL gap configuration (e.g., from the next UL gap periodicity) following activation of the UL gap configuration. In another example, the time at which the UE 102/104/106 applies such a priority rule may differ depending upon, for example, the manner in which the UL gap configuration is activated. If the UL gap configuration is activated by MAC CE, for example, the UE 102/104/106 may apply the UL gap configuration (and the rule to prioritize BPS transmissions) after a three-millisecond MAC CE processing time after the last symbol of the ACK transmission for the PDSCH carrying the MAC CE. Alternatively, if the UL gap configuration is activated by DCI signaling, the UE 102/104/106 may apply the UL gap configuration (and the rule to prioritize BPS transmissions) immediately after the DCI decoding is successful.

Another class of relative priorities between BPS transmissions and UL transmissions may be applied for UL transmissions that are dynamic scheduled signals. A gNB 108 may provide a configuration for a dynamic scheduled signal by, for example, DCI or MAC CE signalling. Examples of dynamic scheduled signals may include a dynamic grant (DG) signal on the PUSCH (DG-PUSCH), an aperiodic CSI (A-CSI) signal on the PUSCH, an aperiodic SRS (A-SRS), or a HARQ-ACK for a DG signal on the PDSCH.

Several options for a priority rule between a BPS transmission and an UL transmission that is a dynamic scheduled signal are now discussed. A first option for a priority rule between a BPS transmission and an UL transmission that is a dynamic scheduled signal is to prioritize the BPS transmission. For example, a network scheduler may apply such a priority rule by avoiding issuing a dynamic grant to schedule a PUSCH transmission, a AP-CSI, a A-SRS, or a HARQ ACK in a UL gap slot of the UL gap configuration, and a UE may apply such a priority rule by ignoring any such dynamic grant that it receives from the gNB as an error.

A second option for a priority rule between a BPS transmission and an UL transmission that is a dynamic scheduled signal is to prioritize certain dynamic scheduled signals. For example, a gNB 108 may issue a dynamic grant to a UE 102/104/106 for a Type 3 HARQ feedback signal (e.g., Type 3 HARQ codebook feedback). It may be desired to prioritize a Type 3 HARQ feedback signal over a conflicting BPS transmission, as type 3 HARQ feedback may carry important HARQ ACK for multiple DL HARQ processes. For example, a gNB may request a Type 3 HARQ feedback signal in order to poll the UE to send all existing HARQ-ACK feedback, regardless of the HARQ-ACK timeline.

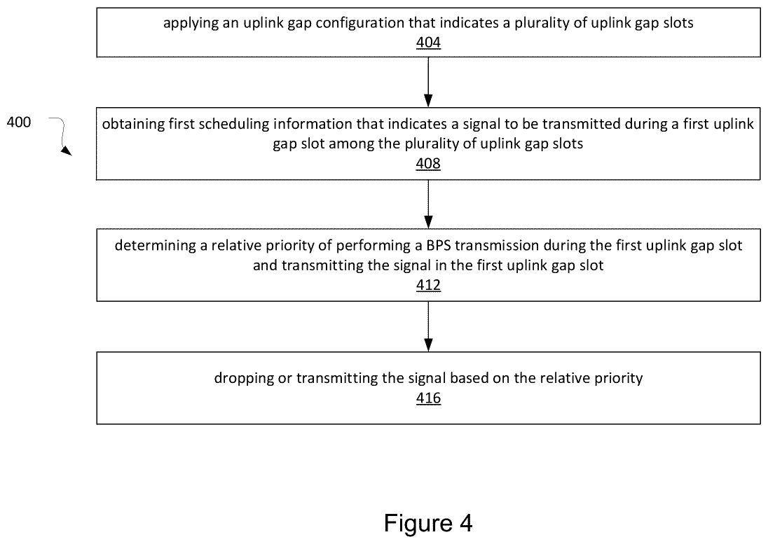

FIGS. 4-7 present a number of operation flows/algorithmic structures in accordance with aspects of this disclosure. These operation flow/algorithmic structures describe a number of operations in a particular sequence. However, the presented sequences are not restrictive. That is, the operations may be performed in sequences other than those specifically presented.

FIG. 4 illustrates an operation flow/algorithmic structure 400 in accordance with some embodiments. The operation flow/algorithmic structure 400 may be performed or implemented by a UE such as, for example, UE 102, 104, 106, or 800; or components thereof, for example, baseband processor 804A.

The operation flow/algorithmic structure 400 may include, at block 404, applying an uplink gap configuration that indicates a plurality of uplink gap slots.

The operation flow/algorithmic structure 400 may include, at block 408, obtaining first scheduling information that indicates a signal to be transmitted during a first uplink gap slot among the plurality of uplink gap slots.

The operation flow/algorithmic structure 400 may include, at block 412, determining a relative priority of performing a BPS transmission during the first uplink gap slot and transmitting the signal in the first uplink gap slot.

The operation flow/algorithmic structure 400 may include, at block 416, dropping or transmitting the signal based on the relative priority. Structure 400 may include, for example, determining that the signal indicated by the first scheduling information is an SRS, and dropping the SRS and performing the BPS transmission during the first uplink gap slot based on a determination that the relative priority prioritizes performing the BPS transmission over transmitting the SRS. Alternatively, structure 400 may include determining that the signal indicated by the first scheduling information is a channel quality indication (CQI) signal, and dropping the CQI signal and performing the BPS transmission during the first uplink gap slot based on a determination that the relative priority prioritizes performing the BPS transmission over transmitting the CQI signal.

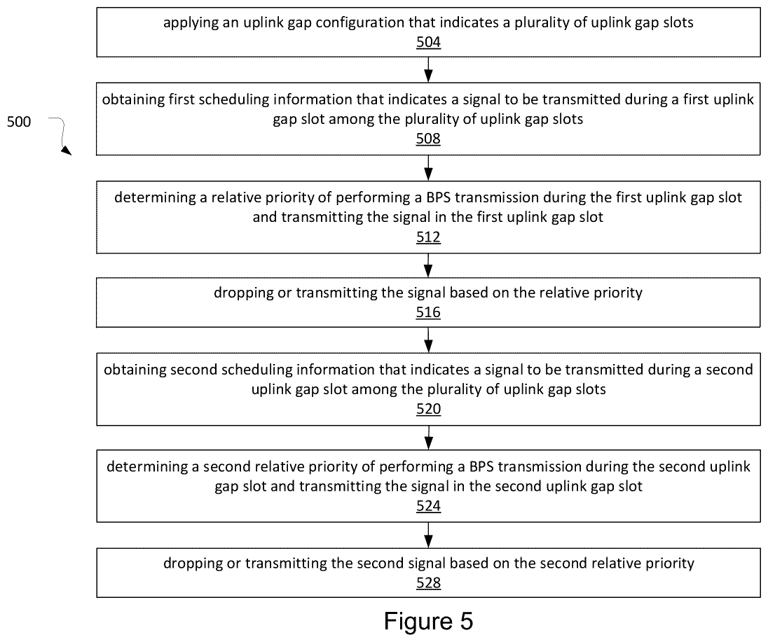

FIG. 5 illustrates an operation flow/algorithmic structure 500 in accordance with some embodiments. The operation flow/algorithmic structure 500 may be performed or implemented by a UE such as, for example, UE 102, 104, 106, or 800; or components thereof, for example, baseband processor 804A.

The operation flow/algorithmic structure 500 may include blocks 504, 508, 512, and 516, which may be similar to blocks 404, 408, 412, and 416, respectively, as described above with respect to FIG. 4. The operation flow/algorithmic structure 500 may include, at block 520, obtaining second scheduling information that indicates a signal to be transmitted during a second uplink gap slot among the plurality of uplink gap slots.

The operation flow/algorithmic structure 500 may include, at block 524, determining a second relative priority of performing a BPS transmission during the second uplink gap slot and transmitting the signal in the second uplink gap slot.

The operation flow/algorithmic structure 500 may include, at block 528, dropping or transmitting the second signal based on the second relative priority. Structure 500 may include, for example, determining that the second signal indicated by the second scheduling information is a BFR signal to be transmitted on the PUCCH, and transmitting the BFR signal during the second uplink gap slot based on a determination that the second relative priority prioritizes transmitting the BFR signal over performing the BPS transmission. Alternatively, structure 500 may include determining that the signal indicated by the second scheduling information is HARQ-ACK for a DL SPS transmission, and transmitting the HARQ-ACK during the second uplink gap slot based on a determination that the second relative priority prioritizes transmitting the HARQ-ACK over performing the BPS transmission. Structure 900 may include, based on the second relative priority, deferring the second uplink gap slot.

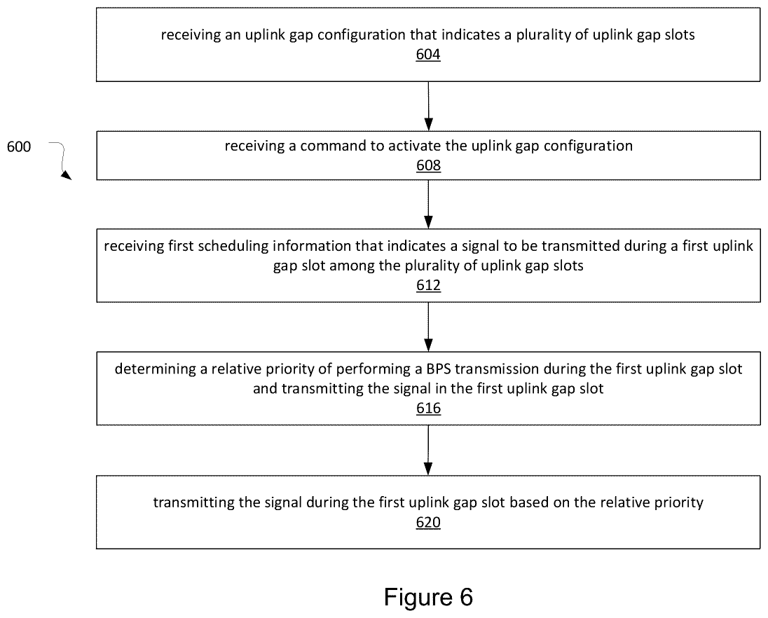

FIG. 6 illustrates an operation flow/algorithmic structure 600 in accordance with some embodiments. The operation flow/algorithmic structure 600 may be performed or implemented by a UE such as, for example, UE 102, 104, 106, or 800; or components thereof, for example, baseband processor 804A.

The operation flow/algorithmic structure 600 may include, at block 604, receiving an uplink gap configuration that indicates a plurality of uplink gap slots. Block 604 may include, for example, receiving the uplink gap configuration in an RRC message (e.g., in one or more RRC IEs).

The operation flow/algorithmic structure 600 may include, at block 608, receiving a command to activate the uplink gap configuration. The uplink gap configuration may include an uplink gap periodicity, and structure 600 may further include applying the uplink gap configuration from the next uplink gap periodicity after receiving the command to activate.

Block 608 may include receiving the command to activate in a DCI message. In this case, structure 600 may include applying the uplink gap configuration immediately after decoding the DCI message. Alternatively, block 608 may include receiving the command to activate in a MAC CE. In this case, structure 600 may include transmitting an ACK of a PDSCH carrying the MAC CE and, after three milliseconds subsequent to transmission of a last symbol of the ACK, applying the uplink gap configuration.

The operation flow/algorithmic structure 600 may include, at block 612, receiving first scheduling information that indicates a signal to be transmitted during a first uplink gap slot among the plurality of uplink gap slots.

Block 612 may include receiving the first scheduling information in a DCI message. In this case, structure 600 may include applying the first scheduling information immediately after decoding the DCI message. The first scheduling information may indicate, for example, that the signal to be transmitted is a HARQ-ACK for a DL SPS transmission. Alternatively, the first scheduling information may indicate, for example, that the signal to be transmitted is a type 2 CG transmission on a PUSCH.

Alternatively, block 612 may include receiving the first scheduling information in a MAC CE. In this case, structure 600 may include transmitting an ACK of a PDSCH carrying the MAC CE and, after three milliseconds subsequent to transmission of a last symbol of the ACK, applying the first scheduling information. The first scheduling information may indicate, for example, that the signal to be transmitted is an SP-CSI report on a PUCCH.

The operation flow/algorithmic structure 600 may include, at block 616, determining a relative priority of performing a BPS transmission during the first uplink gap slot and transmitting the signal in the first uplink gap slot. The operation flow/algorithmic structure 600 may include, at block 620, transmitting the signal during the first uplink gap slot based on the relative priority.

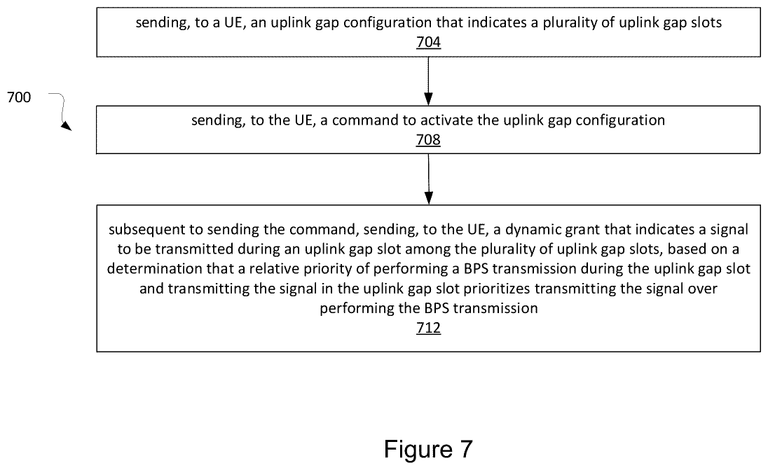

FIG. 7 illustrates an operation flow/algorithmic structure 700 in accordance with some embodiments. The operation flow/algorithmic structure 700 may be performed or implemented by a base station such as, for example, base station 108 or 900; or components thereof, for example, baseband processor 904A.

The operation flow/algorithmic structure 700 may include, at block 704, sending, to a UE, an uplink gap configuration that indicates a plurality of uplink gap slots.

The operation flow/algorithmic structure 700 may include, at block 708, sending, to the UE, a command to activate the uplink gap configuration. Structure 900 may include receiving a request to activate the uplink gap configuration, wherein sending the command is based on the request.

The operation flow/algorithmic structure 700 may include, at block 712, subsequent to sending the command, sending, to the UE, a dynamic grant that indicates a signal to be transmitted during an uplink gap slot among the plurality of uplink gap slots. Sending the dynamic grant may be based on a determination that a relative priority of performing a BPS transmission during the uplink gap slot and transmitting the signal in the uplink gap slot prioritizes transmitting the signal over performing the BPS transmission. Block 712 may include, for example, sending the dynamic grant in a DCI message. The dynamic grant may indicate that the signal to be transmitted is a type 3 HARQ feedback signal. The uplink gap slot may be, for example, a static uplink slot.

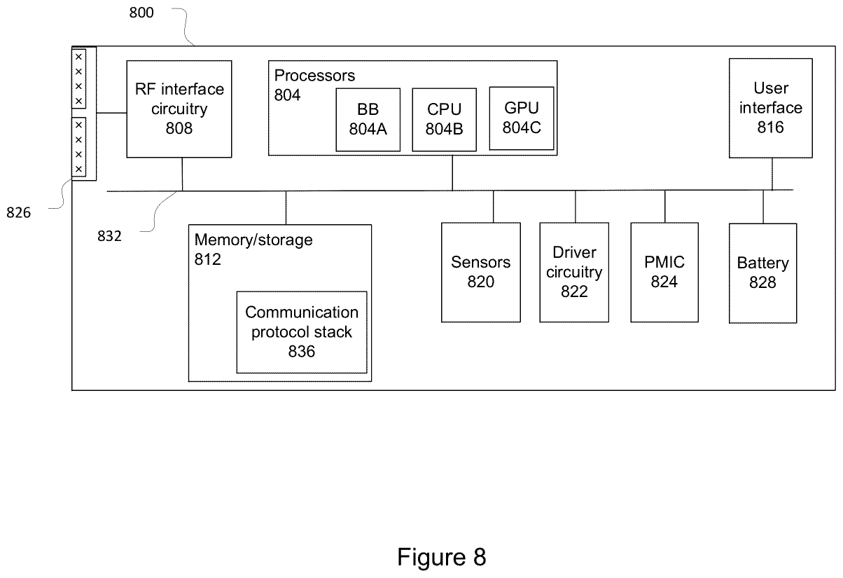

FIG. 8 illustrates a UE 800 in accordance with some embodiments. The UE 800 may be similar to and substantially interchangeable with UEs 102, 104, or 106 of FIG. 1.

The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, optical connection, etc. that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein.

In some embodiments, the baseband processor circuitry 804A may access a communication protocol stack 836 in the memory/storage 812 to communicate over a 3GPP compatible network. In general, the baseband processor circuitry 804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 812 may include one or more non-transitory, computer-readable media that includes instructions (for example, communication protocol stack 836) that may be executed by one or more of the processors 804 to cause the UE 800 to perform various operations described herein. The memory/storage 812 include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, phased array antennas, etc. The antenna 826 may have one or more panels designed for specific frequency bands including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800 including DRX as discussed herein.

A battery 828 may power the UE 800, although in some examples the UE 800 may be mounted deployed in a fixed location, and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

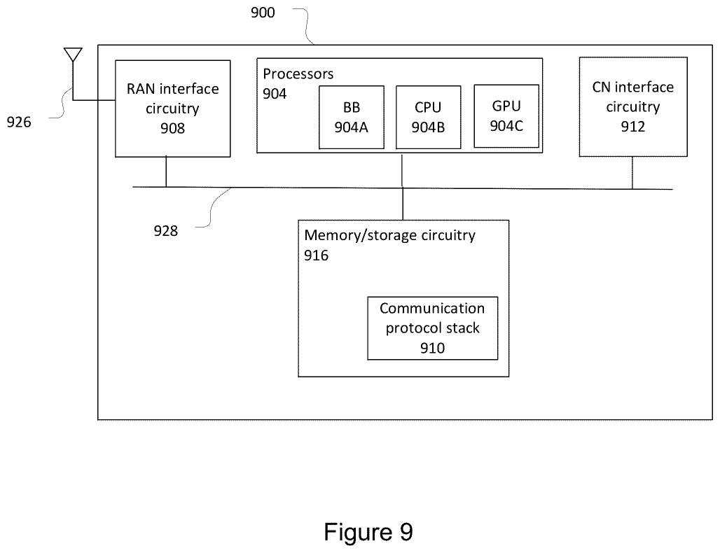

FIG. 9 illustrates an access node 900 (e.g., a base station or gNB) in accordance with some embodiments. The access node 900 may be similar to and substantially interchangeable with access node 108.

The access node 900 may include processors 904, RF interface circuitry 908, core network (CN) interface circuitry 912, memory/storage circuitry 916, and antenna structure 926.

The components of the access node 900 may be coupled with various other components over one or more interconnects 928.

The processors 904, RF interface circuitry 908, memory/storage circuitry 916 (including communication protocol stack 910), antenna structure 926, and interconnects 928 may be similar to like-named elements shown and described with respect to FIG. 8.

The CN interface circuitry 912 may provide connectivity to a core network, for example, a 5^{th} Generation Core network (5GC) using a 5GC-compatible network interface protocol such as carrier Ethernet protocols, or some other suitable protocol. Network connectivity may be provided to/from the access node 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes one or more computer-readable media having instructions that, when executed by one or more processors, cause a UE to apply an uplink gap configuration that indicates a plurality of uplink gap slots; obtain first scheduling information that indicates a signal to be transmitted during a first uplink gap slot among the plurality of uplink gap slots; determine a relative priority of performing a BPS transmission during the first uplink gap slot and transmitting the signal in the first uplink gap slot; and drop or transmit the signal based on the relative priority.

Example 2 includes the one or more computer-readable media of Example 1 or some other example herein, wherein the instructions, when executed by the one or more processors, further cause the UE to determine that the signal indicated by the first scheduling information is a SRS; and drop the SRS and perform the BPS transmission during the first uplink gap slot based on a determination that the relative priority prioritizes performing the BPS transmission over transmitting the SRS.

Example 3 includes the one or more computer-readable media of Example 1 or some other example herein, wherein the instructions, when executed by the one or more processors, further cause the UE to determine that the signal indicated by the first scheduling information is a CQI signal; and drop the CQI signal and perform the BPS transmission during the first uplink gap slot based on a determination that the relative priority prioritizes performing the BPS transmission over transmitting the CQI signal.

Example 4 includes the one or more computer-readable media of Example 1 or some other example herein, wherein the instructions, when executed by the one or more processors, further cause the UE to obtain second scheduling information that indicates a second signal to be transmitted during a second uplink gap slot among the plurality of uplink gap slots; and determine a second relative priority of performing a BPS transmission during the second uplink gap slot and transmitting the second signal in the second uplink gap slot; and drop or transmit the second signal based on the second relative priority.

Example 5 includes the one or more computer-readable media of Example 4 or some other example herein, the instructions, when executed by the one or more processors, further cause the UE to determine that the second signal indicated by the second scheduling information is a BFR signal to be transmitted on a PUCCH; and transmit the BFR signal during the second uplink gap slot based on a determination that the second relative priority prioritizes transmitting the BFR signal over performing the BPS transmission.

Example 6 includes the one or more computer-readable media of Example 4 or some other example herein, wherein the instructions, when executed by the one or more processors, further cause the UE to determine that the second signal indicated by the second scheduling information is a HARQ-ACK for a DL SPS transmission; and transmit the HARQ ACK during the second uplink gap slot based on a determination that the second relative priority prioritizes transmitting the HARQ ACK over performing the BPS transmission.

Example 7 includes the one or more computer-readable media of Example 4 or some other example herein, wherein the instructions, when executed by the one or more processors, further cause the UE to, based on the second relative priority, defer the second uplink gap slot.

Example 8 includes a UE comprising processing circuitry to receive an uplink gap configuration that indicates a plurality of uplink gap slots; receive a command to activate the uplink gap configuration; receive first scheduling information that indicates a signal to be transmitted during a first uplink gap slot among the plurality of uplink gap slots, determine a relative priority of performing a BPS transmission during the first uplink gap slot and transmitting the signal in the first uplink gap slot; and transmit the signal during the first uplink gap slot based on the relative priority. The UE may also comprise memory coupled to the processing circuitry, the memory to store the uplink gap configuration.

Example 13 includes the UE of Example 8 or some other example herein, wherein the processing circuitry is further to receive the command to activate in a MAC CE.

Example 14 includes the UE of Example 13 or some other example herein,

wherein the processing circuitry is further to transmit an ACK of a PDSCH carrying the MAC CE; and after three milliseconds subsequent to transmission of a last symbol of the ACK, apply the uplink gap configuration.

Example 15 includes the UE of Example 8 or some other example herein, wherein the processing circuitry is further to receive the first scheduling information in a DCI message; and apply the first scheduling information immediately after decoding the DCI message.

Example 16 includes the UE of Example 15 or some other example herein, wherein the first scheduling information indicates that the signal to be transmitted is a HARQ-ACK for a DL SPS transmission.

Example 17 includes the UE of Example 15 or some other example herein, wherein the first scheduling information indicates that the signal to be transmitted is a type 2 CG transmission on a PUSCH.

Example 18 includes the UE of Example 8 or some other example herein, wherein the processing circuitry is further to receive the first scheduling information in a MAC CE; transmit an ACK of a PDSCH carrying the MAC CE; and after three milliseconds subsequent to transmission of a last symbol of the ACK, apply the first scheduling information.

Example 19 includes the UE of Example 18 or some other example herein, wherein the first scheduling information indicates that the signal to be transmitted is a SP-CSI report on a PUCCH.

Example 20 includes a method of operating a base station, the method comprising sending, to a UE, an uplink gap configuration that indicates a plurality of uplink gap slots; sending, to the UE, a command to activate the uplink gap configuration; and subsequent to sending the command, sending, to the UE, a dynamic grant that indicates a signal to be transmitted during an uplink gap slot among the plurality of uplink gap slots, wherein sending the dynamic grant is based on a determination that a relative priority of performing a BPS transmission during the uplink gap slot and transmitting the signal in the uplink gap slot prioritizes transmitting the signal over performing the BPS transmission.

Example 21 includes the method of Example 20 or some other example herein, wherein the method further comprises receiving a request to activate the uplink gap configuration, wherein sending the command is based on the request.

Example 22 includes the method of Example 20 or some other example herein, wherein the method further comprises sending the dynamic grant in a DCI message.

Example 23 includes the method of Example 20 or some other example herein, wherein the dynamic grant indicates that the signal to be transmitted is a type 3 HARQ feedback signal.

Example 24 includes the method of Example 20 or some other example herein, wherein the uplink gap slot is a static uplink slot.

Example 25 includes the method of Example 20 or some other example herein, wherein the method further comprises configuring a second dynamic grant that indicates a second signal to be transmitted by the UE during an uplink slot that is not among the plurality of uplink gap slots; and subsequent to sending the command, sending, to the UE, the second dynamic grant.

Example 26 includes the method of Example 25 or some other example herein, wherein the second signal is a data transmission on a PUSCH, an AP-CSI signal, an A-SRS, or a HARQ-ACK.

Example 27 includes the method of Example 25 or some other example herein, wherein sending the second dynamic grant is based on a determination that a second relative priority prioritizes performing the BPS transmission over transmitting the second signal.

Example 28 may include an apparatus comprising means to perform one or more elements of a method described in or related to any of examples 1-27, or any other method or process described herein.

Example 29 may include one or more non-transitory computer-readable media comprising instructions to cause an electronic device, upon execution of the instructions by one or more processors of the electronic device, to perform one or more elements of a method described in or related to any of examples 1-27, or any other method or process described herein.

Example 30 may include an apparatus comprising logic, modules, or circuitry to perform one or more elements of a method described in or related to any of examples 1-27, or any other method or process described herein.

Example 31 may include a method, technique, or process as described in or related to any of examples 1-27, or portions or parts thereof.

Example 32 may include an apparatus comprising: one or more processors and one or more computer-readable media comprising instructions that, when executed by the one or more processors, cause the one or more processors to perform the method, techniques, or process as described in or related to any of examples 1-27, or portions thereof.

Example 33 may include a signal as described in or related to any of examples 1-27, or portions or parts thereof.

Example 34 may include a datagram, information element, packet, frame, segment, PDU, or message as described in or related to any of examples 1-27, or portions or parts thereof, or otherwise described in the present disclosure.

Example 35 may include a signal encoded with data as described in or related to any of examples 1-27, or portions or parts thereof, or otherwise described in the present disclosure.

Example 36 may include a signal encoded with a datagram, IE, packet, frame, segment, PDU, or message as described in or related to any of examples 1-27, or portions or parts thereof, or otherwise described in the present disclosure.

Example 37 may include an electromagnetic signal carrying computer-readable instructions, wherein execution of the computer-readable instructions by one or more processors is to cause the one or more processors to perform the method, techniques, or process as described in or related to any of examples 1-27, or portions thereof.

Example 38 may include a computer program comprising instructions, wherein execution of the program by a processing element is to cause the processing element to carry out the method, techniques, or process as described in or related to any of examples 1-27, or portions thereof.

Example 39 may include a signal in a wireless network as shown and described herein.

Example 40 may include a method of communicating in a wireless network as shown and described herein.

Example 41 may include a system for providing wireless communication as shown and described herein.

Example 42 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. One or more non-transitory computer-readable media having instructions that, when executed by one or more processors, cause a user equipment (UE) to:
apply an uplink gap configuration that indicates a plurality of uplink gap slots;
obtain first scheduling information that indicates a signal to be transmitted during a first uplink gap slot among the plurality of uplink gap slots;
determine a relative priority of performing a body proximity sensing (BPS) transmission during the first uplink gap slot and transmitting the signal in the first uplink gap slot; and
drop or transmit the signal based on the relative priority.

2. The one or more non-transitory computer-readable media of claim 1, wherein the instructions, when executed by the one or more processors, further cause the UE to:
determine that the signal indicated by the first scheduling information is a sounding reference signal (SRS) or determine that the signal indicated by the first scheduling information is a channel Quality indication (COI) signal; and
drop the signal indicated by the first scheduling information and perform the BPS transmission during the first uplink gap slot based on a determination that the relative priority prioritizes performing the BPS transmission over transmitting the signal indicated by the first scheduling information.

3. (canceled)

4. The one or more non-transitory computer-readable media of claim 1, wherein the instructions, when executed by the one or more processors, further cause the UE to:
obtain second scheduling information that indicates a second signal to be transmitted during a second uplink gap slot among the plurality of uplink gap slots;
determine a second relative priority of performing a BPS transmission during the second uplink gap slot and transmitting the second signal in the second uplink gap slot; and
drop or transmit the second signal based on the second relative priority.

5. The one or more non-transitory computer-readable media of claim 4, wherein the instructions, when executed by the one or more processors, further cause the UE to:
determine that the second signal indicated by the second scheduling information is a beam failure recovery (BFR) signal to be transmitted on a physical uplink control channel (PUCCH); and
transmit the BFR signal during the second uplink gap slot based on a determination that the second relative priority prioritizes transmitting the BFR signal over performing the BPS transmission.

6. The one or more non-transitory computer-readable media of claim 4, wherein the instructions, when executed by the one or more processors, further cause the UE to:
determine that the second signal indicated by the second scheduling information is a hybrid automatic repeat request (HARQ) acknowledgement (ACK) for a downlink semi-persistent scheduled (SPS) transmission; and
transmit the HARQ ACK during the second uplink gap slot based on a determination that the second relative priority prioritizes transmitting the HARQ ACK over performing the BPS transmission.

7. (canceled)

8. A user equipment (UE) comprising:
processing circuitry to:
receive an uplink gap configuration that indicates a plurality of uplink gap slots;
receive a command to activate the uplink gap configuration;
receive first scheduling information that indicates a signal to be transmitted during a first uplink gap slot among the plurality of uplink gap slots,
determine a relative priority of performing a body proximity sensing (BPS) transmission during the first uplink gap slot and transmitting the signal in the first uplink gap slot; and
transmit the signal during the first uplink gap slot based on the relative priority, and
memory coupled to the processing circuitry, the memory to store the uplink gap configuration.

9. (canceled)

10. The UE of claim 8, wherein the uplink gap configuration includes an uplink gap periodicity, and
wherein the processing circuitry is further to apply the uplink gap configuration from the next uplink gap periodicity after receiving the command to activate.

11. The UE of claim 8, wherein the processing circuitry is further to receive the command to activate in a downlink control information (DCI) message or in a medium access control (MAC) control element (CE).

12. The UE of claim 8, wherein the processing circuitry is further to:
receive the command to activate in a downlink control information (DCI) message, and
apply the uplink gap configuration immediately after decoding the DCI message.

13. (canceled)

14. (canceled)

15. The UE of claim 8, wherein the processing circuitry is further to:
receive the first scheduling information in a downlink control information (DCI) message; and
apply the first scheduling information immediately after decoding the DCI message.

16. The UE of claim 15, wherein the first scheduling information indicates that the signal to be transmitted is a hybrid automatic repeat request (HARQ) acknowledgement (ACK) for a downlink semi-persistent scheduled (SPS) transmission or that the signal to be transmitted is a type 2 configured grant (CG) transmission on a physical uplink scheduled channel (PUSCH).

17. (canceled)

18. The UE of claim 8, wherein the processing circuitry is further to:
receive the first scheduling information in a medium access control (MAC) control element (CE);
transmit an acknowledgement (ACK) of a physical downlink shared channel (PDSCH) carrying the MAC CE; and
after three milliseconds subsequent to transmission of a last symbol of the ACK, apply the first scheduling information.

19. (canceled)

20. A method of operating a base station, the method comprising:
sending, to a user equipment (UE), an uplink gap configuration that indicates a plurality of uplink gap slots;
sending, to the UE, a command to activate the uplink gap configuration; and
subsequent to sending the command, sending, to the UE, a dynamic grant that indicates a signal to be transmitted during an uplink gap slot among the plurality of uplink gap slots,
wherein sending the dynamic grant is based on a determination that a relative priority of performing a body proximity sensing (BPS) transmission during the uplink gap slot and transmitting the signal in the uplink gap slot prioritizes transmitting the signal over performing the BPS transmission.

21. The method of claim 20, wherein the method further comprises receiving a request to activate the uplink gap configuration, wherein sending the command is based on the request.

22. The method of claim 20, wherein the method further comprises sending the dynamic grant in a downlink control information (DCI) message.

23. The method of claim 20, wherein the dynamic grant indicates that the signal to be transmitted is a type 3 hybrid automatic repeat request (HARQ) feedback signal.

24. The method of claim 20, wherein the uplink gap slot is a static uplink slot.

25. The method of claim 20, wherein the method further comprises:
configuring a second dynamic grant that indicates a second signal to be transmitted by the UE during an uplink slot that is not among the plurality of uplink gap slots; and
subsequent to sending the command, sending, to the UE, the second dynamic grant.

26. The method of claim 25, wherein the second signal is a data transmission on a physical uplink shared channel (PUSCH), an aperiodic channel status indicator (AP-CSI) signal, an aperiodic sounding reference signal (A-SRS), or a hybrid automatic repeat request acknowledgement (HARQ-ACK).

27. The method of claim 25, wherein sending the second dynamic grant is based on a determination that a second relative priority prioritizes performing the BPS transmission over transmitting the second signal.
